(19) United States
(12) Patent Application Publication
(10) Pub. No.: US 2005/0260101 A1
(43) Pub. Date: Nov. 24, 2005

(54) Closure element and closure system

(76) Inventors: Matthias Nauck, Neuenkirchen (DE); Jochem Kotting, Schwanau (DE)

Correspondence Address: EDWARDS & ANGELL, LLP, P.O. BOX 55874, BOSTON, MA, 02205, US

(21) Appl. No.: 10/399,156

(22) PCT Filed: Aug. 3, 2001
(86) PCT No.: PCT/EP01/09016

§ 371 Date: Apr. 10, 2003

(30) Foreign Application Priority Data
Oct. 10, 2000 (DE) 100 50 085.4

(51) Int. Cl. B01L 3/00

(52) U.S. Cl. 422/99

(57) ABSTRACT

A closure element for closing a container or vessel with circular opening is described. It has the shape of a sphere, a sphere segment, a sphere cutout or a sphere layer and is able to releasably close the circular opening at the sphere surface or spherical surface. The closure element and the closure system formed with a container or vessel is very well suited for use in medical, chemical, biochemical, biological and/or analyses or reactions, in particular in medical diagnostics and chemical or biochemical analysis.

The present invention relates to a closure element or a closure system comprising such an element for containers or vessels with circular openings. The closure element or closure system is very well suited for carrying out chemical, biochemical, biological and/or medical analyses or reactions, in particular in medical diagnostics and chemical or biochemical analysis, but also for operating sequences of production.

The problem often arises that open liquid containers should be closed in working processes between individual working steps. Hence, for example in order to avoid evaporation, impurities due to feed, contamination, condensation precipitates, spilling during transport and others, as well as losses in quality associated therewith. Currently, threaded closures, snap-on lids, films, flexible and fixed cover caps are used for this. Since the handling of these closures is time-consuming, technically difficult and impractical for rapid working processes and large series with many vessel openings (intermediate placing of the cover and danger of contamination), it is often completely dispensed with and a loss in quality accepted.

A typical example of a situation in which material is repeatedly removed from a larger quantity of the same vessels over a longer period of time and is therefore left to stand open, is the analytical investigation laboratory. In a medical-diagnostic laboratory, there are for example patient samples (blood, urine etc.), in which various investigations are carried out. After the first opening of the test tube, during a day material samples are removed again and again for new analyses. In a sample number of 50 to 50,000 daily, they cannot be closed again in between individually using the above-mentioned systems. The expense in terms of time and material for this is too high.

Similar situations arise in laboratories of biotechnology, biochemistry and analytical chemistry, or in the production of chemicals, pharmaceuticals, cosmetics and foodstuffs or luxury foods.

For traditional bottles, sphere closures were described a long time ago, see German Patentschrift No. 633 289 (1936) and French 1 089 145 (1955).

The object of the invention was therefore to provide a possibility of being able to reliably close vessels or containers even in the problematic situations outlined above.

To achieve this object, according to the invention a closure element was provided for closing a container or vessel with circular opening, which adopts the shape of a sphere, a sphere segment, a sphere cutout or a sphere layer and is able to releasably close the circular opening at the sphere surface or spherical surface.

In a further object of the invention, such a closure element together with a selectable container or vessel with circular opening forms constituents of a closure system.

A surprisingly simple, versatile, reliable and cost-effective possibility is provided by the present invention of effectively closing open containers, in particular those containing liquids, even in lengthy working processes or production processes and thus avoiding losses in quality. The concept of closing circular openings according to the invention is easily accessible to automisation, which is of considerable advantage for medical diagnostics and other analysis. Since the closure element of the invention on the one hand closes effectively, but on the other hand can be easily released, it is of considerable benefit as a reversible, temporary closure system even for longer breaks in lengthy working processes or methods. With exclusion of contamination, the closure element of the invention can be re-used or designed as an inexpensive disposable article.

The aspects of the present invention, to which the closure element, the closure system as well as processes and devices using the closure concept belong, and the further advantages and preferred embodiments of the invention are illustrated in more detail below with reference to the attached drawings.

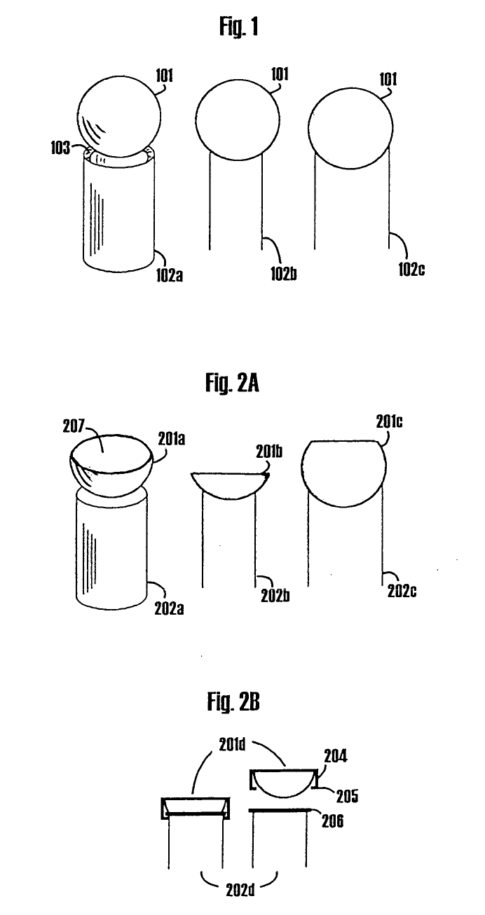

FIG. 1 shows schematically (left perspectively and next to it in cross-section) a closure element and a closure system formed therewith and a container according to the present invention using a full sphere for different opening diameters of the container.

FIG. 2A shows a schematic representation (left perspectively and next to it in cross-section), with which further embodiments of the closure element of the invention are illustrated.

FIG. 2B shows schematically in cross-section a closure system according to one embodiment of the invention, in which additional, reversible fixing is possible.

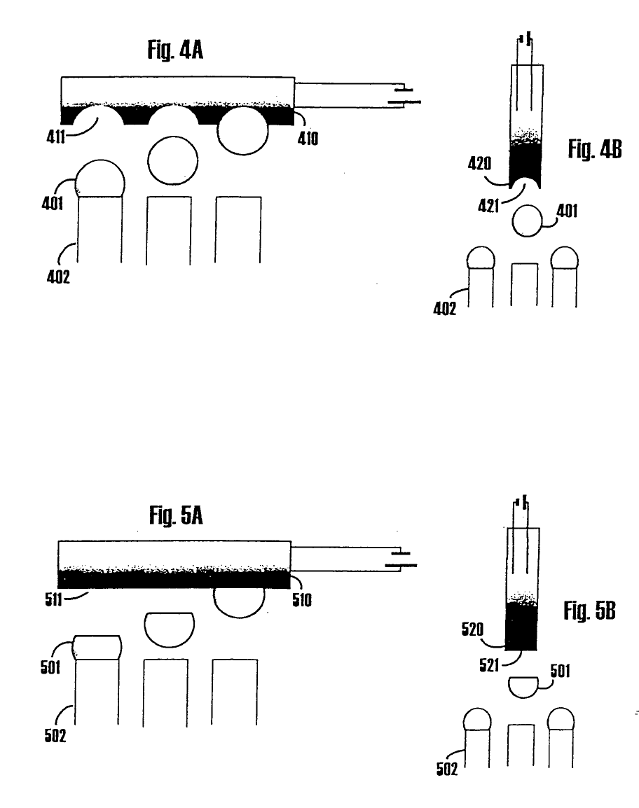

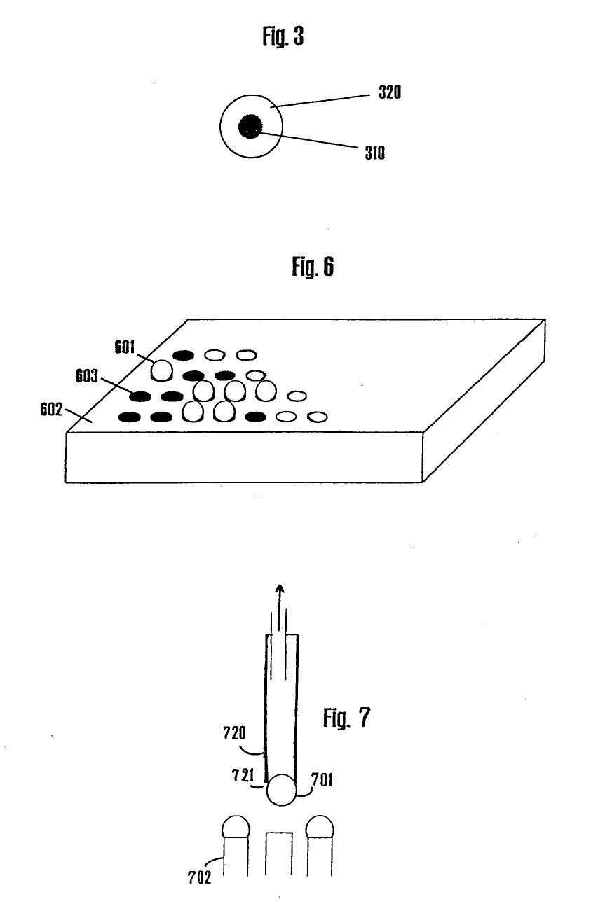

FIG. 3 shows in cross-section the structure of a closure element of the invention in a preferred embodiment, with the aid of which a closure can be released by means of magnetic force.

FIG. 4 shows schematically in cross-section the principle of reversible opening of the closure system of the invention by means of magnetic force according to a preferred embodiment of the present invention, wherein in FIG. 4A or 4B different designs of an electromagnet used are shown.

FIG. 5A or 5B illustrate schematically in cross-section in each case openings of the closure element of the invention corresponding to the representations of FIGS. 4A and 4B, wherein here alternatively, instead of a full sphere, sphere sections are used.

FIG. 6 shows finally schematically in perspective view, a further embodiment of a closure system of the invention using spheres as closure element as well as a vessel having a plurality of circular openings.

FIG. 7 shows schematically in section, reversible opening of the closure system by means of suction force according to a further embodiment of the present invention.

The closure system according to the present invention may be designed in different shapes, assuming that the element, at least in the region with which the circular opening of the container or vessel is to be closed, a sphere surface or spherical surface is provided.

In the preferred case, the closure element has the shape of a (full) sphere, as shown in FIG. 1 by the reference number 101. A sphere shape has the advantages of a simple and cost-effective mode of production and permits diverse design possibilities for handling which is accessible to automisation. With formation of a closure system, the sphere 101 lies stably on the circular opening 103 of the container or vessel 102. However, the closure mechanism can be easily released by raising the sphere, as required, manually or by a mechanical or automatic lifting device, preferably via a magnetic system as described below according to a preferred embodiment. Hence, the system can be opened or closed easily and reversibly by raising or resting the sphere.

The edge on the circular opening of the cylindrical vessel 102a is shown by the reference number 103 in the perspective view (see representation left). In a preferred embodiment, this edge 103 is bevelled, as a result of which the container or the vessel at the circular opening has a surface facing the closure element, which is essentially complementary to the sphere surface of the closure element in the closure region. The closure element rests better on the circular opening in this manner and both the positional stability and the tightness of the closure is improved. However, to simplify production it is not necessary to bevel the edge of the opening, on which the closure sphere sits.

The positional stability of the closure sphere may be positively influenced by further factors. One important factor in this sense is the diameter of the sphere relative to the internal diameter of the round opening. By matching the diameter of the sphere relative to the internal diameter of the opening, the “immersion depth” and hence the stability is determined. This is shown in FIG. 1 in the central and right-hand representation of a closure system using cylindrical vessels 102b and 102c for an equally dimensioned closure sphere 101, wherein the opening of the vessel 102b has a smaller internal diameter compared to that of the vessel 102c. It becomes clear that the “immersion depth” and hence the stability is greater, the lower the difference between the sphere diameter and the internal diameter of the circular vessel opening (see the deeper position in the right-hand compared to the left-hand representation of FIG. 1). On the other hand, the sphere diameter must project beyond the internal diameter of the opening so that resting is possible. The relationship between the percentage difference, by which the sphere radius is greater than the opening radius, and the immersion depth relative to the opening radius is shown in the table below for the case of a full sphere. Good positional stability is achieved when the sphere diameter of the closure element projects beyond the internal diameter of the circular opening by at least 1%, better by at least 10%. For a preset opening diameter, a suitable range for the sphere diameter exists, for example when the sphere diameter is greater than the internal diameter of the circular opening by 5 to 80%, preferably 10 to 60%. Hence, depending on application, a required opening size may be presented. In the laboratory field, for example opening diameters are from 0.2 to 5 cm, more widespread in the range from 0.3 to 2 cm and in particular from 0.5 to 1 cm conventionally. The external diameter on the circular opening of a vessel, provided it is a cylindrically shaped opening at all, may be selected fundamentally independently of the sphere diameter, but is normally lower than the sphere diameter.

TABLE

| Difference between sphere radius and | Immersion depth |
|---|---|
| opening radius [in per cent, relative to | [Factor multiplied by |
| opening radius]) | opening radius] |
| 1% | 0.87 · opening radius |
| 10% | 0.64 · opening radius |
| 20% | 0.53 · opening radius |
| 36% | 0.44 · opening radius |
| 50% | 0.38 · opening radius |
| 60% | 0.35 · opening radius |
| 100% | 0.27 · opening radius |

A further factor which determines the positional stability of the closure sphere, is the specific weight of the sphere. With increasing specific weight, the sphere thus presses more strongly on the opening with the increasing dead weight per unit surface area and thus increases the positional stability. This factor may be varied and adjusted easily by selecting an appropriate sphere material and the thus predetermined specific weight depending on the requirements.

In addition to the full sphere described, further shapes of the closure element of the invention are possible.

FIG. 2A thus shows further exemplary designs of the closure element in the form of different sphere sections (sphere segments). In the representation in FIG. 2A (left perspectively, next to it in cross-section), the circular openings of the particular vessels 202a, 202b and 202c are shown with the corresponding sphere segments 201a, 201b or 202c. The sphere segments thus differ only in that through flat sections, a fictitious, that is imaginary full sphere is truncated either centrally (with formation of a half-sphere, as shown on the left by reference number 201a) or below (central representation, 201b) or above (right-hand representation, 201c) of the fictitious sphere centre, wherein the particular concrete sphere caps ensure the closure function. Also in this embodiment, the centre of gravity of the closure element may be displaced downwards by selecting the size of the sphere segment and thus the positional stability favourably influenced. The flat base circle (see reference number 207) of the particular sphere segment permits in favourable manner after opening, attaching or placing or resting of the closure element on a flat surface.

Further designs of the closure element are a sphere cutout (sphere sector), in which, starting from a sphere segment, on its base circle a sphere section is formed, the tip of which coincides with the central point of the base circle and lies for example in the central point of the fictitious sphere, and a sphere layer, in which, starting from a sphere segment, a further, flat section exists parallel to the first sectional plane.

All designs described of the closure element of the invention correspond as regards their function since the closure of the circular opening is effected at the sphere surface or for the modifications of the full sphere on the remaining, spherical surface of the sphere segment, of the sphere cutout or of the sphere layer. In the embodiments deviating from a full sphere, the statements made above in connection with the full sphere should be applied accordingly. Regarding the description for selecting the diameter, an imaginary full sphere, which is the basis of the particular modification, should thus be used.

In a further embodiment of the invention, the closure sphere may be additionally fixed, if required, by suitable locking elements, so that an indeed reversibly releasable, but more firm closure is possible for longer closure times, for example for transport, archiving, in particular low-temperature storage, etc. Such additional fixing can be easily realised. One possible design of locking is shown in FIG. 2B using the example of a half sphere as closure element, wherein on the right, the open situation and on the left the closed situation of the closure system are shown. In this exemplary design, the cylindrical vessel 202d has an annular thickening (bead) 206 at the upper end of the opening. On the other hand, the semi-circular closure element 201d has an annular cap 204 with a deflected lower end 205. Only the cross-section of the closure system is shown. The cap 204 runs here like a cylinder around the semi-circle. If required, it is however also that instead of that, only narrow pins, which are deflected at the lower end, are attached. In the closed state (shown on the left), the deflected lower end 205 of the cap 204 covers the bead 206 on the ring of the opening, as a result of which quick locking is achieved by means of a re-releasable (reversible) snap-on mechanism. By selecting suitable, flexible plastics, such as for example thermoplastic elastomers, such a reversible snap-on mechanism can be easily realised in the shown or modified design. Other designs of a locking mechanism, taking into account the material for the locking element, the shape of the closure element as well as the design of the vessel at the circular opening, are easily conceivable and familiar enough to the expert. An appropriate clip also facilitates such a closure with the full sphere or further alternative designs of the closure element of the invention. The material for the closure element of the invention may be selected per se as required. The material for the closure element may contain, for example plastic or rubber, glass, ceramic and/or metal, or consist of the said substances. For example the plastics or glass materials conventional for typical laboratory containers or vessels are suitable. Preferred plastic materials include polyolefins, such as polyethylene and in particular polypropylene, polyacrylates, such as polymethylmethacrylate, polycarbonates and polystyrenes as well as copolymers thereof, and furthermore hard rubber. The closure element may thus be formed from transparent or non-transparent, opaque material.

The closure element of the invention may be formed, if required, from one or from more different materials or in the form of a hollow sphere. For example the spherical closure element may be composed of different constituents. Hence, any base material may be coated with a material of certain functionality completely or partly with formation of a surface layer. Hence, the entire closure element or at least the part region of the sphere surface or the spherical surface, which should engage in the circular opening to close the container or vessel, may be made from a material which fulfils at least one of the functions, that the condensation of liquid is inhibited or prevented, that solvent resistance and heat resistance are guaranteed, and that the closure element has high dimensional stability and a low coefficient of expansion. Prevention of liquid condensation is particularly advantageous in analytical processes, since for liquid samples, the concentration of the dissolved materials may be increased by reducing the liquid volume due to condensation on the closure part and thus the analysis results distorted. Also solvent resistance and heat resistance (in particular when the closure element is subjected to recycling cleaning measures, such as washing or autoclaving), high dimensional stability (even in the heat) and a low thermal coefficient of expansion have a favourable effect in the sense of a tight closure and prevention of contamination. Suitable materials for inhibiting or preventing liquid condensation are known, for example fluorinated hydrocarbons, such as polytetrafluoroethylene (PTFE) or fluorine-containing thermoplastics, such as tetrafluoroethylene-hexafluoropropylene copolymer (Teflon@), perfluoroalkoxy copolymer, ethylene-tetrafluoroethylene copolymer, polyvinylidene fluoride, polyvinyl fluoride, polychlorotrifluoroethylene, ethylene-chlorotrifluoroethylene copolymer or the like. Surface treatment of a base material of the closure element is also suitable in order equip the closure element with the required function, for example hydrophobisation by suitable silanes or silicones. Solvent stability is also achieved at the same time using the said materials, but also using polyolefins, such as polyethylene and polypropylene, polyvinyl chloride, polymethylmethacrylate or the like. Dimensionally stable and heat-resistant materials are, for example polypropylene, polycarbonate, polymethylmethacrylate, fluorine-containing plastics, such as polytetrafluoroethylene and polyesters. Materials having relatively low, linear coefficient of thermal expansion are likewise known, for example hard rubber, polycarbonate, polymethylmethacrylate, phenol-formaldehyde resins, urea-formaldehyde resins, unsaturated polyester resins and in particular inorganic materials, such as glass, porcelain and metals, such as aluminium or steel.

Furthermore, it is preferable that the closure system of the invention can be closed to be essentially gas-tight and/or liquid-tight. This may be realised in turn by the use of suitable materials know per se for the functions of gas-tightness or for liquid sealing and which are optionally applied only to the relevant contact point with the circular opening. Further possibilities optionally realised at the same time are produced by suitable constructive measures on the closure system of the invention. The measures already described for observing a relatively high dead weight for the closure element, bevelling on the opening ring to increase the contact surface or the design of a locking device, which may increase the compressive pressure of the closure element on the opening ring, have a positive effect even in this sense.

A further, advancing design according to the invention consists in that the closure element has an identification feature which visible at least externally. This brings advantages with it particularly for series investigations. Suitable identification features are, for example colour features, wherein complete, partial or only surface dyeing are suitable, as well as externally provided inscriptions, engravings, cipher or barcode or the like.

The application of the closure element of the invention is particularly well suited for repeated removal of certain liquid quantities (aliquots) from vessels and containers. Indeed, manual operation is easily possible, particularly for short series runs. However, a particular advantage of the closure system of the invention consists just in that it is easily accessible to mechanisation and automisation, particularly when, as is often the case, large series lengths and long analysis runs occur. In all cases, if required or necessary, a placing support, which has the same or similar circular openings as the containers or vessels to be closed, may serve to place the closure element. When using sphere segments or sphere layers, the closure element may also be placed stably on the base circle surface (see for example reference number 207 in FIG. 2A) facing away from the spherical surface.

Mechanisation for automatic handling may be realised by suitable processing devices. Processes, in which the closure can be released, if required, by means of applying a magnetic field or by means of suction, are preferred as particularly advantageous and particularly easily accessible to automisation. These preferred embodiments of the present invention are illustrated in more detail below. In order to be able to release the closure with the circular opening by means of a producible magnetic field, the closure element of the invention preferably has a core which is formed from a magnetic material, in particular a paramagnetic material. Using the example of a full sphere as closure element, this is illustrated in FIG. 3 in simple and schematic manner. The closure sphere thus comprises a core 310 made from the magnetic, especially paramagnetic material. Paramagnetic materials, normally metals or metal alloys, are adequately known. For example soft irons or paramagnetic steel are well suited. A shell 320 made from any material is formed around this core, wherein the choice of shell material may be effected according to the points of view described above. A combination of a core made from paramagnetic metal, in particular soft irons, and a shell made from plastic is particularly favourable. Then the advantages of a relatively high dead weight due to the high specific density of the metal core may additionally be combined with useful functionalities of a plastic shell, such as for example the characteristics described above of condensation inhibition, solvent resistance and heat resistance and dimensional stability, gas-tightness, liquid tightness etc., wherein the preferences of a cost-effective closure element are retained at the same time. The volume ratios of core to shell constituent of the closure element may thus be freely selected, in particular while observing the said required characteristics.

Reversible opening and closing of the vessel or container openings may be effected by introducing or switching off a magnetic field. This may take place, if required, selectively via a closure element, or at the same time via many closure elements. The strategy of opening can be selected and controlled by the geometry of the magnet used, which is preferably an electromagnet, as shown in FIGS. 4 and 5.

As shown in FIG. 4 using the example of a sphere 401 as closure element, wherein FIG. 4A represents the strategy of opening many closure spheres and FIG. 4B represents the alternative strategy of selective opening of individual closures, the magnetic device 410 or 420 has a contact point with the sphere, at which the magnetic device has a depression 421 (in the case of the alternative according to FIG. 4B) or several depressions 411 (in the case of the alternative according to FIG. 4A). The depressions 411 or 421 are complementary to the sphere or designed to be at least essentially complementary and form a surface-flush contact. The reference number 402 represents the particular vessel.

The same applies for the alternative use of a sphere cutout (sphere sector) as closure element. In this case, the contact point on the magnetic device has a depression which is complementary to the cone section of the sphere cutout.

In the combination with a sphere section (sphere segment) as closure element, the geometry of the electromagnet used is shown in FIGS. 5A and 5B for the particular strategies of simultaneous multiple opening or selective individual opening by means of applying a magnetic field.

In this case, the electromagnets 510 or 520 have a flat surface 511 or 521 facing the closure system, so that a flat boundary surface may be formed at the contact point with the base circle of the sphere segment 501, which is facing away from the opening of the vessel or container. The same applies in the case of a combination (not shown by a figure) with the sphere layer as closure element.

The design of the magnetic device, in particular its geometry and construction as well as its electrotechnical control, are easily possible for the expert taking into account the embodiments shown in FIGS. 4 and 5 and the possibilities for modifying these embodiments.

Alternatively, the closure element of the invention may be opened and closed reversibly according to requirement, in that the closure element is drawn in vertical direction by a suction device for opening, whereas for closing, the suction force of the suction device is reduced or removed in a state, in which the closure elements is situated above the container opening, for uncoupling the closure element from the suction device. FIG. 7 shows simplified in schematic manner such a suction device for reversible opening and closing of a container 702 by a suction device 720. By applying a suction force (for example by air removal in the upper suction pipe element, shown in FIG. 7 by an arrow at the top), the closure sphere 701 is held at the lower end 721 of the suction pipe and may be removed by withdrawing the suction device. For closing, only the suction force needs to be reduced or set to zero in a state and at a point in time, so that the sphere loses the contact from the lower end of the suction pipe due to the gravitational force and comes to rest on the container opening.

Modifications of this embodiment by applying a suction force are easily conceivable, inter alia, taking into account the shape of the closure element, the geometry and the mode of operation of the suction device as well as the possibility of single or multiple opening.

All conceivable or required types, which have circular or essentially circular openings, are suitable as containers or vessels. They may be firstly individual vessels or containers. In medical diagnostics and general analysis and there in particular in series investigations, so-called microcentrifuge tubes are normally used, which are normally formed from plastic resins, such as polypropylene, may accommodate liquid quantities of up to 0.25 ml, 0.4 ml, 0.5 ml, 1.5 ml or more (for example up to 5, 10 or 15 ml) and have circular openings with internal diameters in the range from 0.2 to 5 cm, normally in the range from 0.5 to 1.5 and in particular around 1 cm. These vessels and containers are also well suited to the closure system of the invention. The traditional closure systems likewise occurring in commercially available vessels, such as snap-on lids or threaded closures are however dispensable and may be replaced by the closure element of the invention. The closure system of the invention may thus span the containers, if required, individually, or span several, in combined or combinable form, in appropriate devices, so-called racks.

Alternatively thereto, a plurality of openings may be present in a common container or vessel. Of course, the explanations described above apply to the present invention, which in some cases have been made representative even for those containers or vessels having a plurality of openings, with reference to the simplified individual vessels shown in the attached drawings. In a case, which is typical and preferred for this, the container with the plurality of openings is present as a microtitre plate. Such microtitre plates are conventional for series investigations with assistance of devices for automatic processing. A schematic and exemplary representation for such a vessel is shown in FIG. 6. A plurality of circular openings 603 of a microtitre plate 602, wherein in FIG. 6 only some of the openings are shown, are thus releasably closed individually, only in some cases or completely, by closure elements according to the present invention (closure spheres 601 are shown in the figure by way of example). The number of closure elements can thus be selected independently of the plurality of openings. Hence, if required, one or more closure elements or a number of closure elements corresponding to the number of openings may be present.

When using microtitre plates as a vessel, the concept of the invention is particularly useful for reversible, releasable closing by means of application of a magnetic field as described above. To carry out a closing mechanism according to this preferred embodiment, according to the invention a device for automatically carrying out series investigations on samples present in containers or vessels is also provided. Such investigations conventionally include, as for series investigations, pipetting steps for the removal and/or addition of liquid reagents or samples. The device comprises, in addition to conventional devices of pipetting machines known per se, the special magnetic device described above for reversible opening and closing of circular openings of containers or vessels by means of the closure elements of the invention. As already illustrated, the magnetic device is preferably a controllable electromagnet. Furthermore, the vessel is typically designed as a microtitre plate.

Using the closure element or the closure system as well as the previously described, special device according to the present invention, processes for chemical, biochemical, biological and/or medical analysis or reactions may now be carried out considerably more reliably and in a manner not susceptible to disturbance compared to the state of the art. Considerable advantages result particularly for series investigations. By applying a magnetic field or a suction force by appropriately provided magnetic devices or suction devices, the closure of the openings can be easily reversibly released. Hence, the circular openings of the containers or vessels may be closed before, between and/or after individual pipetting steps of the required analyses or reactions. The step of opening and closing can thus be repeated as required. Also, when using a vessel having a plurality of openings, both simultaneous opening or closing of several or all closure elements, or if required, the controlled and selective opening or closing of individual openings, is possible. If it is required to close or open a plurality of openings, optionally all openings of a common vessel at the same time, the closure elements may be present individually as separate elements. Nevertheless, it may be useful in such a case, to provide a plurality of closure elements corresponding to the plurality of openings, which are firmly connected to one another in each case, in order to simplify the construction of the closure system of the invention. In such a design, the plurality of closure elements are preferably designed in the form of sphere sections (sphere segments, such as for example half spheres) or sphere layers, which are firmly connected to one another via a common support on the side facing away from the openings. The closure unit may then be made, for example by shaping the plurality of spherical sections with the common support via usual shaping techniques, conventionally from suitable plastic materials, integrally to form a unit. Connection or attachment to the common support thus takes place via the base circle surfaces of the closure elements on the side facing away from the openings at such distances that the central points of these base circles and those of circular openings lying underneath essentially cover one another, preferably lie precisely plumb.

The closure element of the invention may be used, if required, once in the form of a disposable article, or alternatively it may be recycled by suitable measures after practical use within the framework of a required analysis or reaction. In order to exclude contamination for further analyses or reactions, measures for washing, autoclaving and the like are suitable for recycling depending on requirement profile and the choice of material for the closure element.

The closure element of the invention may be used generally for covering containers between the partial or complete filling or emptying of the containers. The containers are thus filled with liquids between the covering phases conventionally, for example by means of pipetting aids or pipetting machines, or liquids are removed. As becomes clear from the above description, the closure element and the closure system according to the present invention as well as the processes and devices described are particularly beneficial for use in medical diagnostics, in chemical or biochemical analysis or in the production of chemicals, pharmaceuticals, cosmetics, foodstuffs or luxury foods etc.

In the applications mentioned, the advantages of the invention come particularly to fruition, including simple and rapid handling of the reversible closure mechanism in small and large series, easily realisable, high ability for mechanisation and automisation, developing diverse areas of application and useful functions due to variable diameters and materials of the closure elements on the one hand and of the containers or vessels on the other hand, as well as cost-effective operation by recycling of the closure elements. The use of full spheres is particularly simple and cost-effective with considerable reliability and closing stability. However, other shapes of closure elements are also possible as described and may be advantageous for certain applications. The embodiments outlined should therefore only illustrate the invention, but in no way restrict the general inventive concept defined in the attached patent claims.

1-30. (canceled)

31. A closure element for closing a container or vessel with circular opening, the closure element comprising a core and a surface layer, the closure element having a spherical shape surface comprising a diameter for the closure element to releasably engage with the circular opening of the container or vessel, wherein the core comprises a magnetic material and the surface layer comprises a material selected from the group consisting of a plastic-containing material, a glass-containing material and a ceramic-containing material.

32. The closure element according to claim 31, wherein at least the region of the spherical shape surface that engages the container or vessel in the circular opening comprises a material which fulfils one or more of the following functions: (i) inhibition or prevention of condensation of liquid, (ii) solvent resistance, (iii) heat stability, (iv) high dimensional stability and (v) a low coefficient of expansion.

33. The closure element according to claim 31, further comprising an identification feature that is externally visible.

34. The closure element according claim 31, further comprising a locking element wherein the releasable engagement can be fixed reversibly.

35. A closure system comprising:
a) a container or vessel with circular opening; and
b) a closure element having a spherical shape surface comprising a diameter for the closure element to releasably engage with the circular opening of the container or vessel;
wherein the core comprises a magnetic material and the surface layer comprises a material selected from the group consisting of a plastic-containing material, a glass-containing material and a ceramic-containing material.

36. The closure system according to claim 35, wherein at least the region of the spherical shape surface that engages the container or vessel in the circular opening comprises a material which fulfils one or more of the following functions: (i) inhibition or prevention of condensation of liquid, (ii) solvent resistance, (iii) heat stability, (iv) high dimensional stability and (v) a low coefficient of expansion.

37. The closure element according to claim 35, further comprising an identification feature that is externally visible.

38. The closure element according claim 35, further comprising a locking element wherein the releasable engagement can be fixed reversibly.

39. The closure system according to claim 35, wherein the diameter of the closure element projects beyond the internal diameter of the circular opening by at

40. The closure system according claim 35, the container or the vessel at the circular opening further comprising a second surface facing the closure element that is complementary to the spherical shape surface of the closure element at least in one region of contact.

41. The closure system according claim 35, wherein the system provides an essentially gas-tight and/or liquid-tight closure.

42. The closure system according to claim 35, wherein the container or the vessel comprises a transparent or semi-transparent plastic or glass material.

43. The closure system according to claim 35, wherein the vessel or container comprises a plurality of openings and the closure system further comprises one or more closure elements corresponding to at least a portion of the openings.

44. The closure system according to claim 43, wherein the container or the vessel (a) with the plurality of openings is a microtitre plate.

45. The closure system according to claim 43, wherein a plurality of closure elements corresponding to the plurality of openings are present, and fixed relationship to one another in each case.

46. The closure system according to claim 45, wherein the container or the vessel (a) with the plurality of openings is a microtitre plate.

47. The closure system according claim 35, further comprising:
c) a magnetic device for removing the closure element from the container or vessel by means of a producible magnetic field, or
d) a suction device for removing the closure element from the container or vessel by means of suction force.

48. The closure system according to claim 47, wherein the magnetic device or the suction device comprises a complimentary a contact surface for engaging a surface of the closure element opposite the opening of the container or vessel.

49. The closure system according to claim 48, wherein the contact surface comprises a depression corresponding to a spherical surface or a sphere segment of the closure element.

50. The closure system according to claim 48, wherein the contact surface comprises a flat surface having a base circle of the spherical shape surface segment of the closure element.

51. A closure system comprising:
a) a container or vessel with circular opening;
b) a closure element comprising a spherical shape surface comprising a diameter for the closure element to releasably engage with the circular opening of the container or vessel; and
c) a suction device for removing the closure element from the opening by means of suction force.

52. A process for carrying out a chemical, biochemical, biological and/or medical analysis or reaction with samples or reagents present in a container or vessel, the process comprising:
providing a container or vessel having at least one circular opening, the circular opening being releasably closed with a closure element having a spherical shape surface comprising a diameter for the closure element to releasably engage with the circular opening of the container or vessel;
removing the closure element from the circular opening by applying a magnetic field or a suction to the closure element wherein, when a magnetic field is applied, the closure element comprises a core containing magnetic material and
performing pipetting steps required for carrying out the chemical, biochemical, biological and/or medical analysis or reaction with samples or reagents present in the container or vessel.

53. The process according to one of claims 52, further comprising decontaminating the closure elements after concluding an analysis or reaction and recycling the closure element for closing the circular opening prior to a further analysis or reaction process.

54. The process according to claim 52, wherein the closure element further comprises a shell comprising a material selected from the group consisting of a plastic-containing material, a glass-containing material or a ceramic-containing material.

55. The process according to one of claims 54, further comprising decontaminating the closure elements after concluding an analysis or reaction and recycling the closure element for closing the circular opening prior to a further analysis or reaction process.

56. The process according to claim 52, wherein the circular openings of the containers or vessels are closed before, between and/or after individual pipetting steps of the required analysis or reaction.

57. A method for closing a circular opening in a container or vessel, the method comprising:
providing a closure element having a spherical shape surface comprising a diameter for the closure element to releasably engage with the circular opening of the container or vessel; and
closing the container or vessel with the closure element between partial filling, filling or emptying of the containers.

58. The method according to claim 57, wherein the container or vessel is filled with a liquid between the covering phases or a liquid is removed.

59. The method according to claim 57, further comprising performing medical diagnostics, chemical or biochemical analysis, or the production of chemicals, pharmaceuticals, cosmetics, foodstuffs or luxury foods using the contents of the container or vessel.

60. A device for automatically carrying out series investigations on samples present in a container or vessel having a circular opening that can be releasably closed by a closure element having a spherical shape surface comprising a diameter for the closure element to releasably engage with the circular opening of the container or vessel, wherein the investigations include pipetting steps for the removal and/or addition of liquid reagents or samples, the device comprising:
a conventional structure and configuration of a pipetting machine; and
a magnetic device or a suction device for reversibly opening and closing the circular opening of the container or vessel by removing or replacing the closure element;
wherein, when a magnetic device is used, the closure element comprises a core containing a magnetic material.

61. The device according to claim 60, wherein the magnetic device comprises a controllable electromagnet.

62. The device according to claim 60, the device being structured and arranged for processing microtitre plates.
